(19) United States
(12) Patent Application Publication
(10) Pub. No.: US 2003/0130880 A1
(43) Pub. Date: Jul. 10, 2003

(54) Launch process for a knowledge network

(75) Inventor: Lynne Marie Salinkas, Lafayette, CO (US)

Correspondence Address: John R. Pivnichny, Ph.D., IBM Corporation, N50/040-4, 1701 North Street, Endicott, NY, 13760, US

(73) Assignee: International Business Machines Corporation, Armonk, NY (US)

(21) Appl. No.: 10/041,413

(22) Filed: Jan. 8, 2002

(51) Int. Cl. G06F 17/60

(52) U.S. Cl. 705/8

(57) ABSTRACT

An information technology service provider assists an organization in establishing and using a knowledge network. The organization benefits by sharing expertise between individuals in the network. The process for initially establishing or launching a knowledge network includes forming an initial work group to perform an assessment and develop an enablement plan. The work group selects an executive sponsor, therewith reviewing the assessment and plan. A core team of experts in a domain of knowledge is identified and educated. The core team develops operational plans and guidelines. A database and network tool is provided. A launch meeting is held and plans approved. The core team uses the network tool to share intellectual capital and the organization benefits. Additional members may be recruited. Health check interviews are periodically conducted.

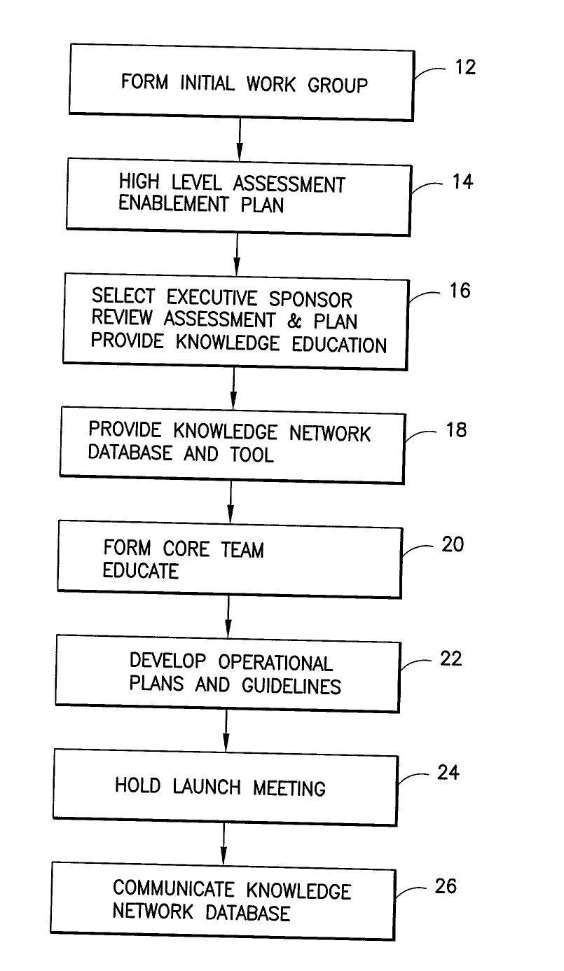

### TECHNICAL FIELD

The invention relates generally to the art of knowledge networks for sharing expertise within an organization. More specifically the invention relates to a method for introducing or launching use of a knowledge network technique or tool within an organization.

### BACKGROUND OF THE INVENTION

The benefits of setting up and employing a knowledge network within an organization are sufficiently well known that various organizations now desire to receive these benefits. For example, Carlos Elizondo describes in the abstract of his paper “Networking your firm's knowledge” published in the journal Chemical Engineering vol. 103, no. 4, April 1996 pages 78-80, a reduction in costs and cycle time for engineering and construction projects in the process industries. Enhanced operation of existing facilities is also achieved resulting in increased agility, leveraging experience, and quick response to market and technology trends.

Authors Sharda and Turethken in the abstract of their paper “Group knowledge networks: a framework and an implementation” published in the journal Inf. Syst. Front. (USA) vol. 1, no. 3, October 1999 pp. 221-39 describe using a knowledge network to support a work group. They report participants were quite satisfied with the new system.

Scherer in the abstract to his paper “The knowledge network: knowledge generation during implementation of application software packages”, Logist. Inf. Manage. (UK) vol. 13, no. 4, 2000 pp. 210-217, describes use of a knowledge network during system implementaton of software.

Sferro et al., in U.S. Pat. No. 6,230,066 B1 describe use of a knowledge network for simultaneously carrying out product engineering and manufacturing.

Gill describes a community of practice within an organization in his article, “Something in Common” in the October 2001 issue of KM Handbook. Steps for building a community of practice are described.

Brizz describes tools for use in knowledge management in his article, “Enterprise Information Portals: An Evaluation of Knowledge Management Tools” in the July 2001 white paper published (online) by Technology Media Group. Specifically he describes use of an enterprise information portal to support management of an organization's knowledge and to support an organization's internal initiatives. Brizz also describes items which must be addressed for a successful portal deployment.

Gill's knowledge management and Brizz's portal, however, are broader in scope than a knowledge network. Organizations wishing to benefit from setting up a knowledge network have more limited and specific expectations. For example, a knowledge network may address a specific knowledge subject area or domain of knowledge. A knowledge network as used herein shall be taken to mean a network of people who do the same kind of job and therefore would use, reuse, and gain benefit from sharing the same information/knowledge. Through use of a knowledge network tool, the people benefit by discovering, sharing, using, and building on what others have learned.

Setting up or launching such a knowledge network within an organization is a necessary first step which if not executed properly will prevent acceptance of any tools such as processors, databases, or services provided. It is therefore of great interest to information technology services providing companies to insure a successful launch of any proposed knowledge network. Otherwise the proposed services and associated hardware such as processors and storage devices for databases will not be used. Furthermore the organization will not receive the expected benefit. A method for successfully launching a knowledge network it is believed would therefore constitute an important advancement in the art.

### OBJECTS AND SUMMARY OF THE INVENTION

It is therefore a principal object of the present invention to provide an enhanced method for launching a knowledge network within an organization.

It is another object to provide a method of sharing knowledge within an organization through use of an enhanced knowledge network launch process.

These and other objects are attained in accordance with one embodiment of the invention wherein there is provided a method of launching a knowledge network within an organization by a service provider, comprising the steps of, forming an initial work group of individuals from the organization and the service supplier, performing by the work group, a high level assessment and developing by the work group, a high level knowledge network enablement plan, selecting an executive sponsor and reviewing the assessment and enablement plan therewith, forming a core team of experts in a domain of knowledge identified in the knowledge network enablement plan, providing pre-launch education to the core team, developing operational plans and guidelines, holding an off-line face-to-face launch meeting of the core team including a presentation by the executive sponsor and presentation of the operational plans and guidelines, and communicating the network to potential new members from the organization.

In accordance with another embodiment of the invention there is provided a method of sharing knowledge within an organization, comprising the steps of, performing an assessment of the organization to identify business need, objectives, expectations, context and domain of knowledge for a knowledge network, preparing a network enablement plan including time schedules, milestones, resources, technology support, and dependencies, reviewing the assessment and the plan with an executive sponsor from the organization, forming a core team of experts in the domain of knowledge, providing a knowledge network database, providing pre-launch education to the core team, developing operational plans and guidelines, holding an off-line face-to-face launch meeting of the core team including presentation of the operational plans and guidelines, and communicating the knowledge network database to potential new members from the organization.

### BRIEF DESCRIPTION OF THE DRAWING

The FIGURE is a flowchart of steps in accordance with the present invention.

### BEST MODE FOR CARRYING OUT THE INVENTION

For a better understanding of the present invention, together with other and further objects, advantages and capabilities thereof, reference is made to the following disclosure and the appended claims in connection with the above-described drawing.

In the FIGURE there is shown a flowchart of steps in accordance with an embodiment of the present invention. An initial work group is formed in step 12. This work group includes individuals from the organization wishing to benefit from launching and using a knowledge network. Individuals from a service provider wishing to assist the organization in the launch process are also included in this initial work group. For example the group may comprise two organization individuals and two service provider individuals. Other combinations may be used. The number of individuals may be specified in a business agreement between the service provider and the organization.

In step 14 the initial work group performs a high level assessment to determine whether the organization is ready for enablement activities. Additional individuals may assist in the assessment under the guidance of the initial work group. The assessment may include the following activities.

a. Identification of business need, objectives, expectations, context and desired scope for a potential knowledge network

b. Creation of a scope and objectives statement for the knowledge network

c. Determination of a general domain of knowledge that the network deals with, creates, or uses

d. Description of viability of the network in terms of scope, type, degree, and mode of participation

e. Determination of the current and desired states for:

network sharing of tacit and explicit knowledge

organizational and cultural climate for the network

executive and management support for network activities

work environment for network members

technical infrastructure and support

f. Determination of critical success factors for moving from the current to the desired states

g. Determination of measurements to assess progress of network activities.

The initial work group prepares a network assessment report.

In step 14 the initial work group also prepares a network enablement plan. The plan will include plans for formation of knowledge network core team of individuals from the organization. The plan may also include technology software and hardware for a knowledge network database. The plan may include education for the core team. Time schedules, milestones, resources, technology support, metrics, and dependencies may be included in the plan. A potential core team leader may be identified.

In step 16 an executive sponsor is selected for launch of the knowledge network. The executive sponsor is a manager in the organization who has an interest in receiving the benefits derived from use of a knowledge network. Depending on an agreement between the organization and the service provider the executive sponsor may be expected to:

gain support from managers for core team time commitments

have an ongoing responsibility to support the network

incorporate network goals into individual performance plans or bonus plans for core team numbers

be available to participate in network activities as requested

actively communicate the importance of sharing and reusing intellectual capital and link it to business objective of the organization

provide incentives to reward creation, sharing, and reuse of intellectual capital

assist a knowledge network leader from the service provider in resolving issues.

The work group reviews the assessment and enablement plan from step 14 with the executive sponsor and obtains approval. Knowledge network education may also be provided to the executive sponsor in step 16.

In step 18 capability is provided for a knowledge network database and a knowledge network tool. The capability may include software knowledge network tools such as ICMAssetWeb, a LOTUS NOTES® (LOTUS NOTES is a registered trademark of Lotus Development Corporation, Cambridge Mass.) based system of linked databases. Hardware such as processors, storage, networking equipment, workstations and other devices known in the art may also be provided for use in operating the knowledge network. Any other type of database may also be provided.

In step 20 a core team is formed. The core team is made up of experts in the domain of knowledge determined by the initial work group in part c of step 14 above. A core team leader may also be selected. The core team is educated in the knowledge network art and in use of the tools and/or databases provided in step 18. Training may be done using conference calls, classroom, on-line tutorial software or any other training methods. A typical core team will have 10 members, however this number may vary based on information gathered in the high level assessment performed in step 14.

By way of example, pre-launch education of the core team will typically be completed using a kickoff and three conference calls between the core team members and a knowledge network leader from the service provider. During a kickoff call, members are introduced to the purpose of the knowledge network, its mission, and the members of the core team. Registration for use of the tool provided as well as e-meeting software may be completed. Available on-line tutorial materials and an education package are reviewed.

During a first call, the knowledge network leader will focus training on the use of the tool provided in step 18. During a second call, the leader provides a live system demonstration, using e-meeting techniques, of the tool. The demonstration may include use of tool features such as navigation, mobility, help desk, a database walkthrough, structure and layout of the database, submission process (for submitting knowledge to the database), approval process (for approval of submitted knowledge by a designated subject matter expert), and how to collaborate in the knowledge network.

During a third call the knowledge network leader will present an example of operational plans and guidelines to the core team.

In step 22 the core team develops a draft of operational plans and guidelines based on the example presented in call 3 and the particular characteristics of the domain of knowledge and core team members in their knowledge network.

In step 24 a launch meeting is held. This meeting is preferably a two day, off-line, face-to-face meeting of the core team members. The terminology off-line face-to-face shall be taken to mean that the core team members meet in person at a single location or physical room and not through use of electronic conferencing, video conferencing, or other remote means. The meeting may include a presentation by the executive sponsor, which may include information linking the knowledge network to business objectives of the organization. The launch meeting includes presentation of the draft operational plans and guidelines developed in step 22. The core team approves and/or modifies the draft.

The launch meeting may also include generation or final approval of a submission process, membership maintenance plan, a measurements and incentives plan, a database maintenance plan, a communications plan, and any other items specific to the particular core team.

After the launch meeting, the core team starts using the knowledge network including managing and maintaining existing and newly developed intellectual capital including submissions, in accordance with the plans developed during the pre-launch period and at the launch meeting. The organization starts to benefit from the knowledge network.

For the organization to receive additional benefit from the knowledge network, other individuals from the organization are invited to participate in the network. Such other members need not be experts in the domain of knowledge addressed by the network, but should have an interest in learning more about this domain. The core team members in step 26 communicate the existence, status, and operational guidelines to such individuals, thereby inviting participation and reception of benefit from participation in the knowledge network. Health check interviews may be conducted periodically. A report based on the interviews may be sent to the executive sponsor or core team to provide feedback.

While there have been shown and described what are at present considered the preferred embodiments of the invention, it will be obvious to those skilled in the art that various changes and modifications may be made therein without departing from the scope of the invention as defined by the appended claims.

What is claimed is:

1. A method of launching a knowledge network within an organization by a service provider, comprising the steps of:
forming an initial work group of individuals from said organization and said service supplier;
performing by said work group, a high level assessment and developing by said work group, a high level knowledge network enablement plan;
selecting an executive sponsor and reviewing said assessment and enablement plan therewith;
forming a core team of experts in a domain of knowledge identified in said knowledge network enablement plan;
providing pre-launch education to said core team;
developing operational plans and guidelines;
holding an off-line face-to-face launch meeting of said core team including a presentation by said executive sponsor and presentation of said operational plans and guidelines; and
communicating said network to potential new members from said organization.

2. The method of claim 1, further comprising the step of providing knowledge education to said executive sponsor.

3. The method of claim 1, further comprising the step of providing a knowledge network database.

4. The method of claim 3, wherein said pre-launch education includes training in the use of said knowledge network database.

5. The method of claim 1, wherein said operational plans and guidelines includes the topics of operations, communication, education, incentives, measurements, submission guidelines, database maintenance, and membership management.

6. The method of claim 1, wherein said operational plans comprise documents including a communications plan, an education plan, a team operations document, a membership maintenance plan, a measurements and incentives plan, and a database maintenance plan.

7. The method of claim 1, further comprising the step of selecting a leader for said core team.

8. The method of claim 1, further comprising the step of providing direction to said core team.

9. The method of claim 8, wherein said direction is provided using e-meeting technology.

10. The method of claim 1, further comprising the step of conducting health check interviews and providing a health check report based on said interviews.

11. A method of sharing knowledge within an organization, comprising the steps of:
performing an assessment of said organization to identify business need, objectives, expectations, context and domain of knowledge for a knowledge network;
preparing a network enablement plan including time schedules, milestones, resources, technology support, and dependencies;
reviewing said assessment and said plan with an executive sponsor from said organization;
forming a core team of experts in said domain of knowledge;
providing a knowledge network database;
providing pre-launch education to said core team;
developing operational plans and guidelines;
holding an off-line face-to-face launch meeting of said core team including presentation of said operational plans and guidelines; and
communicating said knowledge network database to potential new members from said organization.

12. The method of claim 11, further comprising providing a knowledge network tool to said organization.

13. The method of claim 12, wherein said pre-launch education includes training in the use of said tool and said database.

14. The method of claim 11, wherein said operational plans and guidelines includes the topics of operations, communication, education, incentives, measurements, submission guidelines, database maintenance, and membership management.

15. The method of claim 11, wherein said operational plans comprise documents including a communications plan, an education plan, a team operations document, a membership maintenance plan, a measurements and incentives plan, and a database maintenance plan.

16. The method of claim 11, further comprising the step of selecting a leader for said core team.

17. The method of claim 11, further comprising the step of providing direction to said core team.

18. The method of claim 17, wherein said direction is provided using e-meeting technology.

19. The method of claim 17, wherein said direction is provided by a plurality of teleconferences with said core team including a review of progress in implementing said operational plans.

20. The method of claim 11, further comprising the step of conducting health check interviews and providing a health check report based on said interviews.
